(19) United States
(12) Patent Application Publication
(10) Pub. No.: US 2007/0165943 A1
(43) Pub. Date: Jul. 19, 2007

(54) System and method for image registration using nonparametric priors and statistical learning techniques

(76) Inventors: Christoph Guetter, Princeton, NJ (US); Daniel Cremers, Bonn (DE); Chenyang Xu, Allentown, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/602,045

(22) Filed: Nov. 20, 2006

Related U.S. Application Data
(60) Provisional application No. 60/759,326, filed on Jan. 17, 2006.

(51) Int. Cl. G06K 9/62; G06K 9/00; G06K 9/32

(52) U.S. Cl. 382/159; 382/294; 382/128

(57) ABSTRACT

A method for image registration includes receiving first and second image information. A library of joint intensity distributions, spanning a space of non-parametric statistical priors, derived from earlier perfect matching results is received. From among this library, a preferred learned joint intensity distribution is automatically selected during the registration process. As a result, a displacement field is generated both (i) maximizing the statistical dependency between an intensity distribution of the first and second image information and (ii) minimizing the statistical distance to the learned joint intensity distributions. The generated displacement field is used to transform an image structure from the first image information to an image structure of the second image information.

### REFERENCE TO RELATED APPLICATION

The present application is based on provisional application Ser. No. 60/759,326, filed Jan. 17, 2006, the entire contents of which are herein incorporated by reference.

### BACKGROUND

1. Technical Field

The present disclosure relates to image registration and, more specifically, to a system and method for image registration using nonparametric priors and statistical learning techniques.

2. Description of the Related Art

Computer vision is the science of using computers to interpret multi-dimensional image data. Computer vision is in many ways analogous to biological vision, the visual perception of humans and various animals.

Medical imaging is the science and practice of imaging the human body for the purpose of rendering a clinical diagnosis. Medical imaging often involves the use of medical imaging techniques such as Computed Tomography (CT), Positron Emission Tomography (PET), Medical Ultrasonography, Ultrasound (US), and Magnetic Resonance Imaging (MRI). Each medical imaging technique may be perfumed by a suitable scanner with the same name.

Modern medical imaging devices often record image data in digital form, and computer vision techniques are increasingly being employed in the analysis of medical diagnostic images to facilitate diagnosis and treatment of various medical conditions including disease, injury and congenital defect. By using computerized image processing, a patient may be scanned from multiple angles and a three-dimensional image may be constructed based on the collected data. Each three-dimensional image may be made up of planar slices, and the image as a whole may be digitally represented as a three-dimensional matrix of digital volume elements called voxels. Alternatively, two-dimensional images may be obtained, with each two-dimensional image being comprised of a two-dimensional matrix of pixels.

Image registration is the process of transforming different sets of image data into a single coordinate system. When multiple images are taken of a patient using the same medical imaging device, image registration may be able to rely on similarities between patterns of pixels in the reference image (the original image) and the target image (the image that the reference image is being mapped to) to determine how the original image and the target image relate. This process may involve various shape matching techniques. Image registration generally results in the calculation of a deformation field (u). The deformation field is an expression of the mathematical relationship between the original image and the target image. By calculating the deformation field, multiple images may be related to one another to construct a more detailed and three-dimensional image or to monitor how structures change from one point in time to another.

Image registration may be rigid, where corresponding image features maintain a fixed position relative to each other. Alternatively, image registration may be non-rigid, where the relative position of corresponding features may change as the subject moves or contorts.

When multiple images are taken with different scanning modalities and/or when multiple images are taken at different points in time, image registration may be complicated. For example, when a first scan is performed by CT and a second scan is performed by PET, the same structural features may look very different as the two modalities may assign different intensities to the same structural features.

### SUMMARY

A method for image registration includes receiving first and second image information. A library of joint intensity distributions, spanning a space of non-parametric statistical priors, derived from earlier perfect matching results is received. From among this library, a preferred learned joint intensity distribution is automatically selected during the registration process. As a result, a displacement field is generated both (i) maximizing the statistical dependency between an intensity distribution of the first and second image information and (ii) minimizing the statistical distance to the learned joint intensity distributions. The generated displacement field is used to transform an image structure from the first image information to an image structure of the second image information.

A system for image recognition includes a first-information receiving unit to receive first image information. A second-information receiving unit receives second image information. A selecting unit automatically selects a preferred learned joint intensity distribution from among a library of learned joint intensity distributions. A generating unit generates a displacement field both (i) maximizing the statistical dependency between an intensity distribution of the first and second image information and (ii) minimizing the statistical distance to a learned joint intensity distribution. A registration unit uses all the components above to generate a displacement field that registers an image structure from the first image information to an image structure of the second image information.

A computer system includes a processor and a program storage device readable by the computer system, embodying a program of instructions executable by the processor to perform method steps for image registration. The method includes receiving first and second image information. A library of joint intensity distributions, spanning a space of non-parametric statistical priors, derived from earlier perfect matching results is received. From among this library, a preferred learned joint intensity distribution is automatically selected during the registration process. As a result, a displacement field is generated both (i) maximizing the statistical dependency between an intensity distribution of the first and second image information and (ii) minimizing the statistical distance to the learned joint intensity distributions. The generated displacement field is used to transform an image structure from the first image information to an image structure of the second image information.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a schematic plot of energy according to an exemplary embodiment of the present invention;

FIG. 2 shows the registration performance analysis of the SPECT slice and the CT image;

FIGS. 3A-3D illustrate different registration problems characterized by different joint intensity distributions;

FIGS. 4A-4C illustrate the use of several prior distributions according to an exemplary embodiment of the present invention;

FIGS. 5A-5H illustrate facial images used for training and registration;

FIGS. 6A-6F illustrate facial image registration results; and

FIG. 7 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide sophisticated techniques for image registration, for example, to relate medical images taken with different scanning modalities, for example, CT and PET. However, the exemplary embodiments described herein may be easily applied to image registration in other fields such as process control, event detection, image segmentation, and image recognition.

As discussed above, classical image registration techniques are based on the assumption that corresponding pixels have similar intensity values. In practice, this assumption is often violated, especially where image registration occurs between medical images taken with different scanning modalities and/or at different times.

Maximum Mutual Information is a powerful statistical criterion for image registration. In Maximum Mutual Information registration, a deformation field û is found that maximizes the statistical dependency between the intensity distributions of the original and target image:

$$\hat{u} = arg {max}_{u} {I}_{MI} ( {f}_{1} ( x ) , {f}_{2} ( x + u ( x ) ) ) \qquad ( 1 )$$

where f₁ and f₂ are the two images (original and target) and I_{MI} denotes the mutual information of the two distributions. This may also be written as:

$${I}_{MI} ( {f}_{1} ( x ) , {f}_{2} ( x + u ( x ) ) ) = {\int }_{{ℜ}^{2}} {p}_{u} ( {i}_{1} , {i}_{2} ) log \frac{{p}_{u} ( {i}_{1} , {i}_{2} )}{{p}_{{f}_{1}} ( {i}_{1} ) {p}_{{f}_{2}} ( {i}_{2} )} d {i}_{1} d {i}_{2} \qquad ( 2 )$$

where i₁=f₁(x), i₂=f₂(x+u(x)), and p_{f1}(i₁), p_{f2}(i₂), pᵤ(i₁,i₂) are the marginal and joint intensity distributions estimated from f₁(x) and f₂(x+u(x)).

By maximizing constraint (1), correspondence between pixels is not based on the assumption that intensities of common features be similar. Instead, it is assumed that the intensity distributions of the matched features be maximally dependent. Correspondence of intensity pairs therefore arises from the two matched images.

In practice, however, information needed to make this determination may be corrupted or incomplete. For example, the two images may be deteriorated by noise and/or image features may be missing or occluded form one of the images. In the context of medical imaging, for example, a tumor may be visible in only one of the images. In this case, the corrupted low-level information may be insufficient to accurately determine a correct intensity correspondence. The matching of the occluded region to respective image areas from the first to the second image may even deteriorate the estimated intensity transformation between the matched images and hence it may bias a non-rigid transformation that may be simultaneously estimated. Moreover, image registration, as described above, may depend on local optimization by intensity gradient descent and may require an initial estimate of the intensity transformation between the two images. If the initial estimate is too far off from the final matching, then correct registration may be prevented.

Prior knowledge, otherwise known as statistical priors, derived from a previous successful matching may be used to facilitate image registration. For example, statistical priors may be used in forming the initial estimate of the intensity transformation between the reference and target images. Accordingly, statistical priors may be applied to estimate transformations, for example, those described above, as a framework for non-rigid deformations that allows for multiple learned joint intensity distributions.

Statistical priors may be computed from respective joint intensity distributions that have been successfully matched. Statistical priors may be non-linear and may be derived by kernel density estimates in the space of joint intensity distributions. Statistical priors may then be introduced into the image registration process using, for example, the framework of Bayesian inference.

Bayesian inference is a method of statistical inference where observations are used to update or to newly infer the probability that a hypothesis may be true. Bayesian inference is based on Bayes' theorem for adjusting probability in light of new evidence:

$$P ( {H}_{0} \vert E ) = \frac{P ( E \vert {H}_{0} ) P ( {H}_{0} )}{P ( E )} \qquad ( 3 )$$

By utilizing the Bayesian framework, the subsequent image matching process may be driven by maximization of statistical dependence of the individual intensity distribution. This may favor matching results for which the resulting joint intensity distribution is statistically consistent with the set of learned joint intensity distributions. Accordingly, statistical priors are imposed on the joint intensity distribution modeling the intensity transformations from one image to the other.

For example, there may be a representative set of preregistered image pairs {f₁^{j}, f₂^{j}}_{j=1, . . . ,m} where fₖ^{j}: Ω⊂ [symbol] These image pairs may be obtained from various image modalities and three-dimensional image slice locations. Each registered image pair gives rise to a specific joint intensity distribution pⱼ(i₁,i₂), stating which intensities i₁ and i₂ are likely to be in correspondence for a given image pair. This knowledge may be imposed into various image registration algorithms.

In the framework of Bayesian inference, the problem of non-rigid image registration can be solved by finding the most likely deformation field u given the two images f₁ and f₂ and given the set of previously learned joint intensity distributions {pⱼ}_{j=1, . . . ,m}. The conditional distribution may therefore be maximized by the formula:

P(u,pᵤ|f₁,f₂{pⱼ}) ∝P(f₁,f₂|u,pᵤ,{pⱼ})P(u,pᵤ|{pⱼ}) (4)

∝P(f₁,f₂|u,pᵤ)P(u)P(pᵤ|{pⱼ})

with respect to the deformation field u. Herein, proportionality ∝ represents that only factors that do not depend on the deformation field u and thus do not affect the maximization have been neglected.

Optimization of the above formula (4) may be separated into three factors. The first factor indicates how consistent, or likely, the previously observed joint distributions are with respect to the current intensity transformation as given by the two images f₁(x) and f₂(x+u). The second factor indicates how likely the observed images f₁ and f₂ are, given the deformation field u. The third factor specifies the a priori-probability of the deformation field u. Each of these three factors is modeled below.

With respect to the first factor of equation (4), it may be assumed that the registration of the two images f₁ and f₂ with deformation field u gives rise to a joint intensity distribution pᵤ(i₁,i₂). The first factor may be modeled by supposing that a set of joint intensity distributions {pⱼ}_{j=1, . . . ,m} is more likely given a deformation field u and two images f₁ and f₂ if the joint intensity distribution associated with the two registered images is close to the kernel density estimator computed from the set of joint intensity distributions:

$$\begin{matrix}P ( {p}_{u} \vert \{ {p}_{j} \} ) ∝ \frac{1}{m} {\sum }_{j = 1}^{m} exp ( - \frac{{I}_{KL} ( {p}_{u} , {p}_{j} )}{σ} ) \\ where , & ( 5 ) \\ {I}_{KL} ( {p}_{u} , {p}_{j} ) = {\int }_{{ℜ}^{2}} {p}_{u} ( {i}_{1} , {i}_{2} ) log \frac{{p}_{u} ( {i}_{1} , {i}_{2} )}{{p}_{j} ( {i}_{1} , {i}_{2} )} d {i}_{1} d {i}_{2} & ( 6 )\end{matrix}$$

denotes KL divergence measuring the dissimilarity between a given intensity distribution pᵤ and the previously learned joint distribution pⱼ. In the optimization (4), the distribution (5) imposes a statistical similarity between the inferred intensity correspondence pᵤ and the previously observed joint intensity distribution {pⱼ}_{j=1, . . . ,m}. The kernel width σ in the density estimator is fixed to the average nearest neighbor distance computed for the set of joint intensity distributions {pⱼ}:

$$σ = \frac{1}{m} {\sum }_{i = 1}^{m} {min}_{j \neq i} {I}_{KL} ( {p}_{i} , {p}_{j} ) \qquad ( 7 )$$

### Other methods for estimating the kernel width may be used, for example, using cross validation.

With respect to the second factor of equation (4), Maximum Mutual Information hold that two images f₁ and f₂ are more likely to correspond if the two distributions of corresponding intensities f₁(x) and f₂(x+u) are maximally dependent:

P(f₁,f₂|u,pᵤ)∝exp(α₁I_{MI}(f₁(x),f₂(x+u))) (8)

### The mutual information I_{MI} is defined above in equation (2). In the statistical inference (3) this constraint will favor deformation fields u which maximize the statistical dependency between the two intensity distributions.

With respect to the third factor of equation (4), a statistical prior may be imposed on the deformation field u to indicate which deformation fields are a priori more or less likely. Such statistical priors may be learned, for example, from training sequences of optic flow fields. The priors may be successfully imposed in the statistical inference. For example, a common smoothness prior may be imposed on the deformation field:

P(u)∝exp(−α²∫|∇u|²dx) (9)

Other priors may be used, for example, non-quadratic (robust) smoothness priors that allow for discontinuities in the estimated deformation fields.

Using the three factors of the inference problem (4), the probability may be maximized by minimizing the negative logarithm which may be given by an energy of the form:

E(\dot{u})=Eₚᵣᵢₒᵣ(u)+α₁E_{MI}(u)+α₂Eₛₘₒₒₜₕ(u) (10)

Where the three energies Eₚᵣᵢₒᵣ, E_{MI}, and Eₛₘₒₒₜₕ impose several constraints. The energy Eₚᵣᵢₒᵣ, establishes that the joint intensity distribution induced by a deformation u is consistent with previously observed joint intensity distributions. Eₚᵣᵢₒᵣ is defined as:

$${E}_{prior} ( u ) = - log ( {\sum }_{j = 1}^{m} exp ( - \frac{{I}_{KL} ( {p}_{u} , {p}_{j} )}{σ} ) ) \qquad ( 11 )$$

The energy E_{MI} is defined according to mutual information criterion as:

E_{MI}(u)=−I_{MI}((f₁(x),f₂(x+u)) (12)

The prior on the deformation field u gives the smoothness constraint:

Eₛₘₒₒₜₕ(u)=∫|∇u|²dx (13)

Minimization of the energy E(u) of (10) by gradient descent leads to a partial differential equation for u in the form:

$$\frac{\partial u}{\partial t} = - \frac{\partial E ( u )}{\partial u} = - \frac{\partial {E}_{prior} ( u )}{\partial u} - {α}_{1} \frac{\partial {E}_{MI} ( u )}{\partial u} - {α}_{2} \frac{\partial {E}_{smooth} ( u )}{\partial u} \qquad ( 14 )$$

The gradient of Eprior(u) may be expressed as:

$$\frac{\partial {E}_{prior} ( u )}{\partial u} = \frac{1}{σ} {\sum }_{j = 1}^{m} {γ}_{j} \frac{\partial {I}_{KL} ( {p}_{u} , {p}_{j} )}{\partial u} \qquad ( 15 )$$

with normalized weights:

$$\begin{matrix}{γ}_{j} = \frac{{\hat{γ}}_{j}}{{\sum }_{i} {\hat{γ}}_{i}} \\ where , & ( 16 ) \\ {\hat{γ}}_{j} = exp ( - \frac{{I}_{KL} ( {p}_{u} , {p}_{j} )}{σ} ) & ( 17 )\end{matrix}$$

### The gradient of I_{KL}(pᵤ,pⱼ) is computed with respect to the displacement field u using the Gateaux derivative giving the gradient in direction ũ:

$$\frac{\partial {I}_{KL}}{\partial u} {\vert}_{\tilde{u}} = {lim}_{ɛ -> 0} \frac{1}{ɛ} ( {I}_{KL} ( {p}_{u + ɛ \tilde{u}} , {p}_{j} ) - {I}_{KL} ( {p}_{u} , {p}_{j} ) ) \qquad ( 18 )$$

using the definition of the joint intensity distribution

$${p}_{u} ( {i}_{1} , {i}_{2} ) ≡ \frac{1}{\vert Ω \vert} {\int }_{Ω} {G}_{ρ} ( {i}_{1} - {f}_{1} ( x ) , {i}_{2} - {f}_{2} ( x + u ) ) d x \qquad ( 19 )$$

where G_{ρ} is a two-dimensional Gaussian distribution of width ρ. Accordingly:

$${p}_{u + ɛ \tilde{u}} = {p}_{u} + ɛ \int \tilde{u} \frac{\partial {G}_{ρ}}{\partial {i}_{2}} ( {i}_{1} - {f}_{1} , {i}_{2} - {f}_{2} ) ∇ {f}_{2} d x \qquad ( 20 )$$

where f₂ and ∇f₂ are evaluated at x+u(x). Inserting the equation (20) into (18) and further linearization gives the directional derivative:

$$\frac{\partial {I}_{KL} ( {p}_{u} , {p}_{j} )}{\partial u} {\vert}_{\tilde{u}} = \int ( \frac{\partial {I}_{KL} ( {p}_{u} , {p}_{j} )}{\partial u} ) \tilde{u} ( x ) d x \qquad ( 21 )$$

with the gradient given by:

$$\frac{\partial {I}_{KL} ( {p}_{u} , {p}_{j} )}{\partial u} = \frac{1}{\vert Ω \vert} \cdot [ {G}_{ρ} * ( \frac{{\partial }_{{i}_{2}} {p}_{u} ( {i}_{1} , {i}_{2} )}{{p}_{u} ( {i}_{1} , {i}_{2} )} - \frac{{\partial }_{{i}_{2}} {p}_{j} ( {i}_{1} , {i}_{2} )}{{p}_{j} ( {i}_{1} , {i}_{2} )} ) ] ( {f}_{1} , {f}_{2} ) \cdot ∇ {f}_{2} \qquad ( 22 )$$

where f₂ and ∇f₂ are evaluated at x+u(x).

Using a Gaussian kernel exp(−I_{KL}²/(2σ²)) rather than an exponential one as used in (5) will lead to an additional factor of I_{KL}/σ in equation (15), which is believed to provide beneficial convergence properties as the gradient approaches zero for pᵤ→pⱼ.

The additional term (15) induces a change in the estimated deformation field u which seeks to minimize the KL-distance I_{KL}(pᵤ,pⱼ), thereby drawing the present intensity distribution pᵤ towards the previously learned distributions {pⱼ}. The energy gradient exerts a force on the estimated intensity distribution toward each learned intensity distribution pⱼ which is modulated with a weight γⱼ that decays exponentially with the distance between the intensity distributions, as seen in equation (17). Thus, this additional term comes into play for those learned distributions which are most consistent with the currently estimated intensity distribution. By this mechanism the best intensity distribution is selected from among the learned intensity distributions for the given registration task.

Accordingly, an intensity distribution may be selected for each particular registration task from among a selection of intensity distributions based upon a library of statistical priors. In each case, the best statistical prior; for example, the statistical prior that is most likely to contribute to an accurate image registration, may be determined and utilized to facilitate accurate image registration.

Because the best statistical prior is selected from a library of statistical priors, as the library of statistical priors increases, for example, as more image registrations are performed, the system's ability to accurately perform image registration increases and the system gets “smarter.” The number of statistical priors that may be collected and considered is practically unbounded, and accordingly, system accuracy may be perpetually improved. Therefore, a single system according to one or more exemplary embodiments of the present invention may be able to effectively register images by overcoming a wide variety of registration problems.

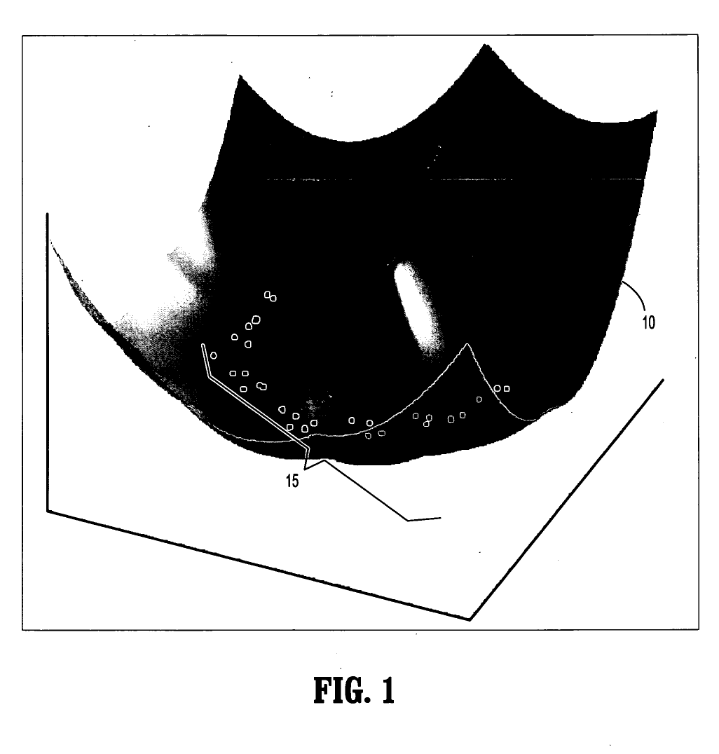

The effect of the multimodal energy (11) may be seen in FIG. 1. FIG. 1 is a schematic plot of energy (11). Each point in 15 represents a joint intensity distribution pⱼ. The energy (5) generated by all learned points is shown as a shaded surface 10. The shaded surface 10 essentially extends the KL-divergence to a dissimilarity with respect to an entire set of joint intensity distributions. During the optimization process, the displacement field is constrained such that the corresponding intensity distribution remains within the valleys of low energy. Accordingly, the joint intensity distribution favors similarity to previously learned intensity distributions during optimization.

For example, assume that the library of statistical priors includes two joint distributions. The first joint distribution states that white pixels in a first image are always associated with black pixels in a second image and vice versa. The second joint distribution states that the matching of white pixels to white pixels and black pixels to black pixels is most likely. In this case, enforcing similarity to one or the other joint distribution by energy as defined in formula (11) has the following effect: If during optimization pairs of white pixels are associated through the displacement field, then this induces proximity to the second learned intensity distribution, and the prior will automatically enforce that black should also be associated with black. This is because a matching of white-to-white on one hand but black-to-white on the other is not consistent with any of the two learned intensity distributions. Accordingly, the matching of certain intensities will provide clues for the matching of others, as indicated by the learned joint distributions and the joint intensity distribution is forced to be similar to one or the other previously learned intensity distributions.

The above example illuminates the idea of imposing a prior on the space of joint intensity distributions. This allows for a large variety of different intensity distributions. Additionally, the inherent selection mechanism allows for inferring the statistical relationship between matching of different intensity pairs, as in the simple example of two joint distributions discussed above.

A quantitative study on a SPECT and CT image pair shows that priors on the joint intensity distribution can improve the mutual-information-based registration process by increasing the basin of attraction and by shifting to the correct location of the energy minimum. A study on the registration of a PET and CT image pair shows that the multimodal prior on the joint intensity distribution outperforms a simpler unimodal prior, because the multimodal prior allows the registration process to “select” among appropriate joint distributions.

During these studies, all implementations are executed within a multi-resolution framework, giving computation times around 10 seconds for two-dimensional image pairs of size 450×450 pixels.

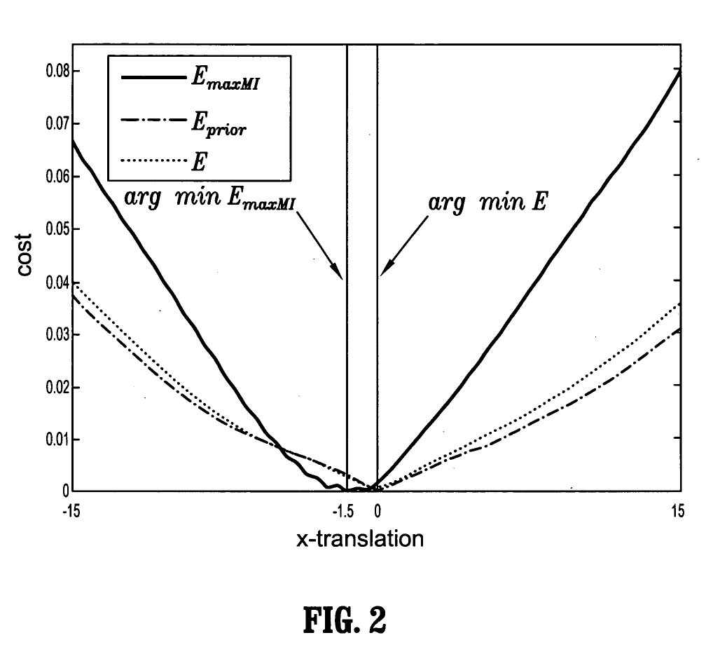

Assuming a perfectly aligned image data set, the performance of competing objective functions, e.g. E_{maxMI}=max(I_{MI})−I_{MI} for MI, Eₚᵣᵢₒᵣ in (11) and the total energy E in (10), is studied. In this experiment, a SPECT slice was shifted horizontally, while a CT image remained fixed, and the respective values of all three objective functions were computed. FIG. 2 illustrates the registration performance analysis of the SPECT slice and the CT image. Here, the SPECT slice was shifted horizontally within a range of −15 mm to 15 mm. Noise may be seen around the optimum and its minimum and as a result, the minimum corresponds to an incorrect alignment. The integration of the prior on the joint intensity distribution selected according to an exemplary embodiment of the present invention provided for a larger basin of attraction and enabled the estimation of the correct alignment.

The energy plots of FIG. 1 show quantitatively that incorporating a prior (computed from the correctly aligned image pair) will lead to superior registration. While this is shown for the case of translation, similar improvements may be expected for non-rigid deformations.

Given several training image pairs, the proposed prior can incorporate a variety of joint intensity distributions. Experimentation shows that among this complementary information, the method of an exemplary embodiment of the present invention selectively chooses the intensity information appropriate for a specific registration task.

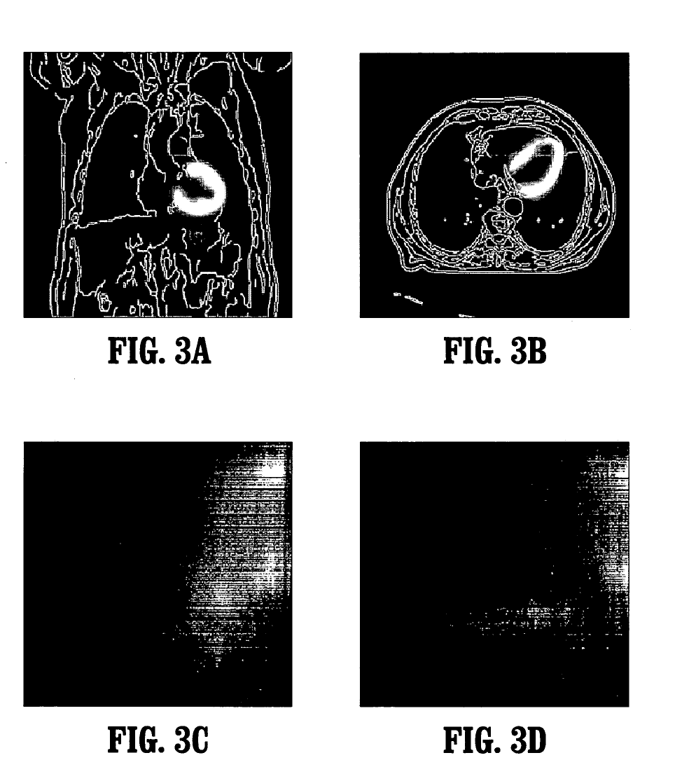

The training data is composed of two sets of aligned PET—CT slices acquired by a Siemens hybrid scanner. PET and SPECT are nuclear imaging techniques which visualize centers of high glucose activity in the human body. FIGS. 3A-D illustrate different registration problems characterized by different joint intensity distributions. FIG. 3A illustrates registration of coronal PET and CT slices. FIG. 3B illustrates registration of axial PET and CT slices. The superimposed edge maps (shown in white) illustrate structural information of the CT image and visualize the quality of alignment. FIG. 3C illustrates a joint intensity histogram for the coronal registration problem shown in FIG. 3A and FIG. 3D illustrates a joint intensity histogram for the axial registration problem shown in FIG. 3B. Note the significant difference between the two shown joint intensity distributions of FIG. 3C and FIG. 3D. These exemplary cases reflect a typical scenario as it occurs in clinical applications.

An artificial deformation is applied to the PET slices and compared to the recovered displacement fields of using only a single prior distribution versus selecting from the two priors according to an exemplary embodiment of the present invention. The two priors represent the joint distribution of the axial and coronal PET—CT slices shown in FIGS. 3A-D. In the case of a single prior, the average of the two is used as a fair comparison.

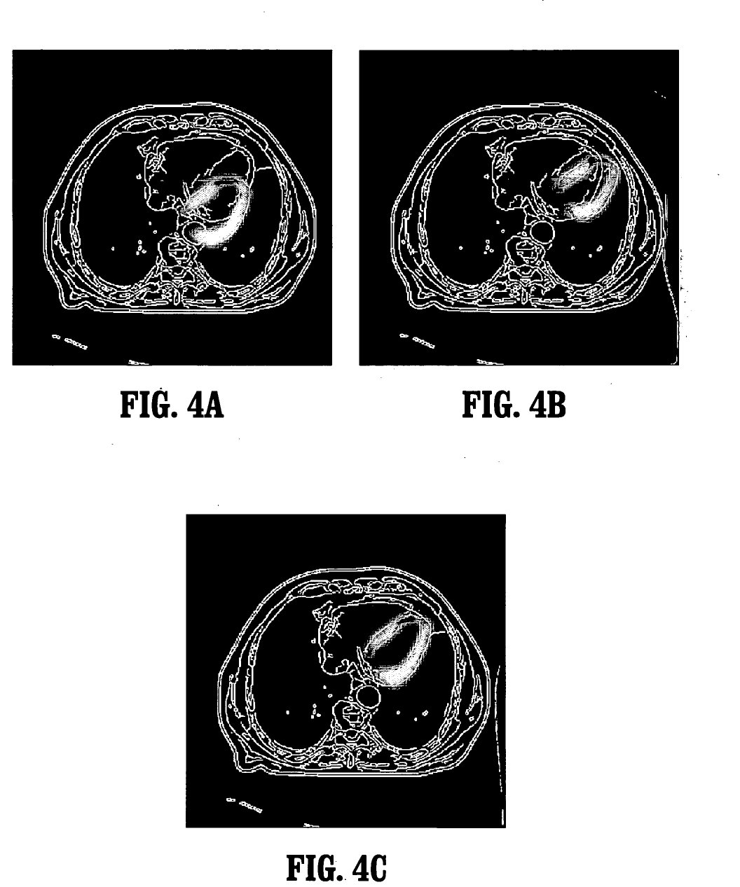

FIGS. 4A-C illustrate the use of several prior distributions according to an exemplary embodiment of the present invention, here, with respect to PET/CT registration. Weighing factors of the energy (10) may be set with a preference towards the prior energy Eₚᵣᵢₒᵣ. For example, α₁ may be chosen to be small. The width σ is determined using equation (7), and α₂ may be chosen to allow for a smooth displacement field.

FIG. 4A illustrates the deformation between the PET and the CT images. The results of recovering the significant deformation between the PET and CT images is illustrated in FIGS. 4B and 4C. FIG. 4B illustrates the results of registration using the single average prior. FIG. 4C illustrates the result of automatically selecting between the library of both available priors. While using the single average prior leads to misregistration and a registration failure as can be seen in FIG. 4B, the multimodal prior on the joint intensity distribution allows for the correct registration as can be seen in FIG. 4C.

Exemplary embodiments of the present invention can fully utilize the given priors and correctly “select” the closest joint intensity distribution. As a result, the underlying deformation is fully recovered, as can be seen in FIG. 4C.

While embodiments of the present invention can chose the best available prior information, in cases where there is no particular best information available, the prior energy decays to zero, and performance will be at least as good as using a context-free similarity measure.

As described above, image registration has practical application beyond the field of medical image analysis. Embodiments of the present invention may be applicable to all applications of image registration. For example, non-rigid multi-modal registration can serve as a preprocessing step for face recognition, where facial and/or head motion must be recovered in order to establish correspondence.

An embodiment of the present invention is tested to illustrate how prior knowledge on the joint intensity distribution provides effective registration of facial images, even in the presence of lighting variation and occlusion.

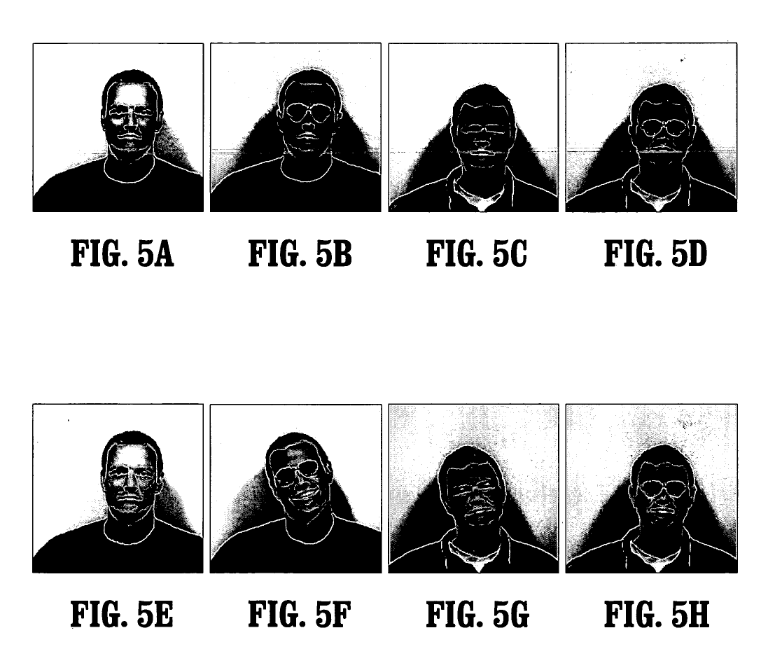

In this experiment, facial images including variations in expressions and head position are registered. FIGS. 5A-5H illustrate facial images used for training and registration. FIGS. 5A-5D are training images and FIGS. 5E-5H are reference and alignment images that are subject to registration. FIGS. 5A and 5E represent a facial image with a standard expression taken in standard lighting. FIGS. 5B and 5F are taken under different lighting conditions with the subject wearing sun glasses. The objective functions of comparison are (i) purely MI based registration and (ii) the combined approach using prior knowledge in equation (10) according to an exemplary embodiment of the present invention. FIGS. 5A-D show two pairs of manually registered training data used to construct the prior, e.g. m=2. For the sake of clarity, we chose m to be equal to 2. The method is by no means limited to m=2, and, it becomes more powerful for m extremely larger than 2. To compare the performance, the same images are registered (i) by the context-free MI criterion and (ii) by additionally imposing a prior on the space of joint intensity distributions. The parameters used here are similar to the previous experiment described above. FIGS. 5E-5H show the reference and alignment images that are subject to registration. The images show multi-modality due to a slight illumination change and due to the presence of the sun glasses.

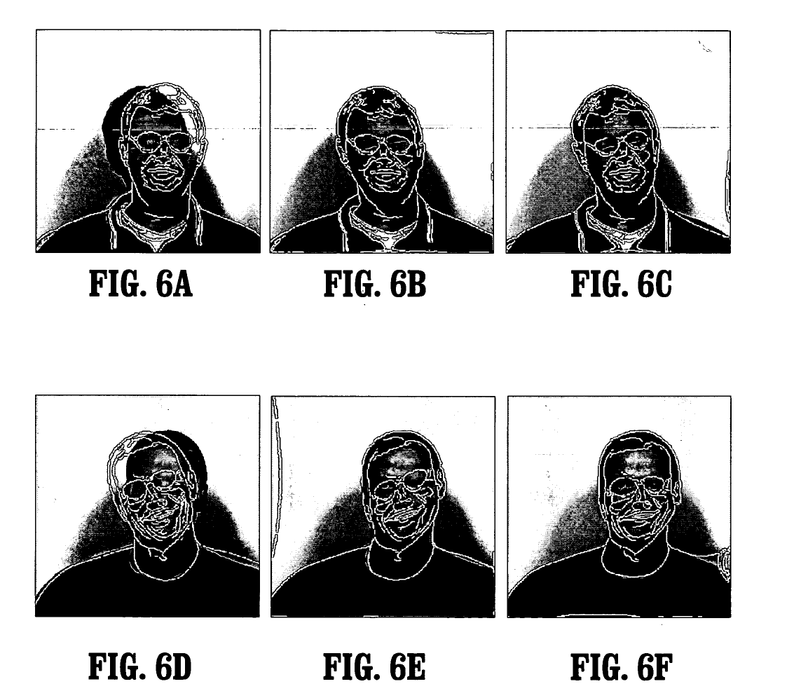

FIGS. 6A-F show facial image registration results. Since the underlying transformation is unknown, the edge map of the alignment image is superimposed on the reference image for performance comparison. FIGS. 6A and 6D show initial alignment of the two images. FIGS. 6B and 6E show the final registration for the pure MI-based energy. The MI method matches the outline of the persons correctly but fails to match the glasses in the alignment image on the eye region of the reference image. FIGS. 6C and 6F show the final registration using the energy formula (10) according to an exemplary embodiment of the present invention. This approach selects the intensity distribution which corresponds best to the current input images. FIGS. 6C and 6F illustrate accurate registration by minimizing the distance towards previously learned intensity distributions.

The multimodal prior on the joint intensity distribution is used according to exemplary embodiments of the present invention to enhance image registration accuracy. MI is shown to provide a powerful registration criterion, however, it remains a purely low-level criterion. Exemplary embodiments of the present invention enhances this existing registration method in order to integrate prior knowledge about likely intensity correspondences, which is statistically learned from multiple pairs of pre-registered training images. Experimental results on both medical and face images demonstrate the effectiveness of this approach.

While the exemplary embodiments are herein described with reference to two-dimensional images, these embodiments may be extended three dimensional images.

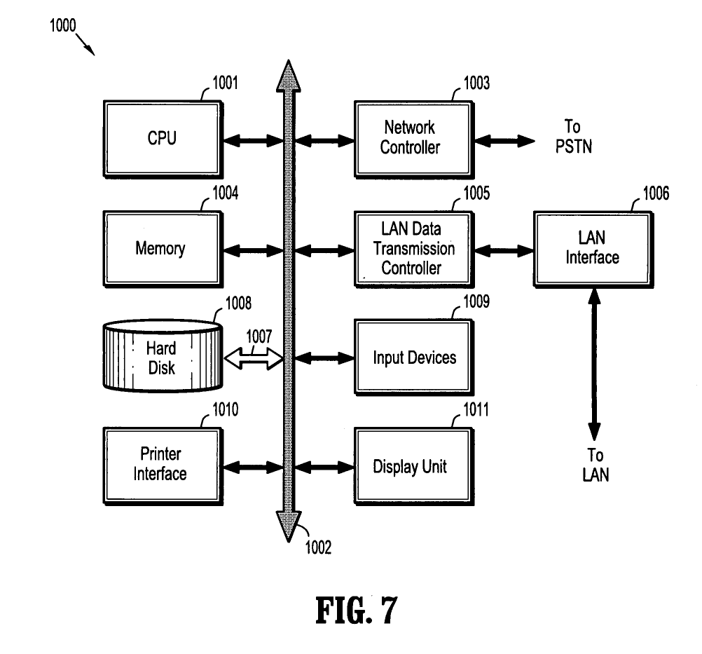

FIG. 7 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for image registration, comprising:
receiving first image information;
receiving second image information;
automatically selecting a preferred learned joint intensity distribution from among a library of learned joint intensity distributions;
generating a displacement field both (i) maximizing the statistical dependency between an intensity distribution of the first and second image information and (ii) minimizing the distance to a learned joint intensity distribution; and
using the generated displacement field to transform an image structure from the first image information to an image structure of the second image information.

2. The method of claim 1, wherein a library of joint intensity distributions spans a space of non-parametric statistical priors derived from earlier registrations.

3. The method of claim 1, wherein the first image information represents a first medical image and the second medical information represents a second medical image.

4. The method of claim 3, wherein the first medical image is an image of a subject taken with a first medical imaging device and the second medical image is an image of the subject taken with a second medical imaging device different than the first medical imaging device.

5. The method of claim 3, wherein the first medical image is an image of a subject taken at a first time and the second medical image is an image of the subject taken at a second time later than the first point in time.

6. The method of claim 1, further comprising adding a joint intensity distribution to the library of learned joint intensity distributions based on the generated displacement field.

7. The method of claim 1, wherein the ability to accurately generating a displacement field increases as the library of learned joint intensity distributions increases.

8. The method of claim 1, wherein the automatically selecting a preferred learned joint intensity distribution from among a library of learned joint intensity distributions comprises minimizing the energy E for the displacement field u, according to the formula: E(u)=Eₚᵣᵢₒᵣ(u)+α₁E_{MI}(u)+α₂Eₛₘₒₒₜₕ(u), wherein
$${E}_{prior} ( u ) = - log ( {\sum }_{j = 1}^{m} exp ( - \frac{{I}_{KL} ( {p}_{u} , {p}_{j} )}{σ} ) ) ;$$
$${E}_{MI} ( u ) = - {I}_{MI} ( ( {f}_{1} ( x ) , {f}_{2} ( x + u ) ) ; \\ {E}_{smooth} ( u ) = \int {\vert ∇ u \vert}^{2} d x ;$$
α₁, and α₂ are the respective contributions of the mutual information and smoothness;
$${I}_{KL} ( {p}_{u} , {p}_{j} ) = {\int }_{{ℜ}^{2}} {p}_{u} ( {i}_{1} , {i}_{2} ) log \frac{{p}_{u} ( {i}_{1} , {i}_{2} )}{{p}_{j} ( {i}_{1} , {i}_{2} )} d {i}_{1} d {i}_{2} ; and$$
$$σ = \frac{1}{m} {\sum }_{i = 1}^{m} {min}_{j \neq i} {I}_{KL} ( {p}_{i} , {p}_{j} ) .$$

9. A system for image recognition, comprising:
receiving first image information;
receiving second image information;
automatically selecting a preferred learned joint intensity distribution from among a library of learned joint intensity distributions;
generating a displacement field both (i) maximizing the statistical dependency between an intensity distribution of the first and second image information and (ii) minimizing the distance to a learned joint intensity distribution; and
using the generated displacement field to transform an image structure from the first image information to an image structure of the second image information.

10. The system of claim 9, wherein a library of joint intensity distributions spans a space of non-parametric statistical priors derived from earlier registrations.

11. The system of claim 9, wherein the first image information represents a first medical image and the second medical information represents a second medical image.

12. The system of claim 11, wherein the first medical image is an image of a subject taken with a first medical imaging device and the second medical image is an image of the subject taken with a second medical imaging device different than the first medical imaging device.

13. The system of claim 11, wherein the first medical image is an image of a subject taken at a first time and the second medical image is an image of the subject taken at a second time later than the first point in time.

14. The system of claim 9, further comprising an adding unit to add a joint intensity distribution to the library of learned joint intensity distributions based on the generated displacement field.

15. The system of claim 9, wherein the ability to accurately generating a displacement field increases as the library of learned joint intensity distributions increases.

16. The system of claim 9, wherein the selecting unit automatically selects a preferred learned joint intensity distribution from among a library of learned joint intensity distributions comprises minimizing the energy E for the displacement field u, according to the formula: E(u)=Eₚᵣᵢₒᵣ(u)+α₁E_{MI}(u)+α₂Eₛₘₒₒₜₕ(u), wherein
$${E}_{prior} ( u ) = - log ( {\sum }_{j = 1}^{m} exp ( - \frac{{I}_{KL} ( {p}_{u} , {p}_{j} )}{σ} ) ) ;$$
$${E}_{MI} ( u ) = - {I}_{MI} ( ( {f}_{1} ( x ) , {f}_{2} ( x + u ) ) ; \\ {E}_{smooth} ( u ) = \int {\vert ∇ u \vert}^{2} d x ;$$
α₁ and α₂ are the respective contributions of the mutual information and smoothness;
$${I}_{KL} ( {p}_{u} , {p}_{j} ) = {\int }_{{ℜ}^{2}} {p}_{u} ( {i}_{1} , {i}_{2} ) log \frac{{p}_{u} ( {i}_{1} , {i}_{2} )}{{p}_{j} ( {i}_{1} , {i}_{2} )} d {i}_{1} d {i}_{2} ; and$$
$$σ = \frac{1}{m} {\sum }_{i = 1}^{m} {min}_{j \neq i} {I}_{KL} ( {p}_{i} , {p}_{j} ) .$$

17. A computer system comprising:
a processor; and
a program storage device readable by the computer system, embodying a program of instructions executable by the processor to perform method steps for image registration, the method comprising:
receiving first image information;
receiving second image information;
automatically selecting a preferred learned joint intensity distribution from among a library of learned joint intensity distributions;
generating a displacement field both (i) maximizing the statistical dependency between an intensity distribution of the first and second image information and (ii) minimizing the distance to a learned joint intensity distribution; and
using the generated displacement field to transform an image structure from the first image information to an image structure of the second image information.

18. The computer system of claim 17, wherein the selected preferred joint intensity distribution is used as an initial estimate of the intensity distribution of the first image information and the second image information.

19. The computer system of claim 17, wherein a library of joint intensity distributions spans a space of non-parametric statistical priors derived from earlier registrations.

20. The computer system of claim 19, wherein the first medical image is an image of a subject taken with a first medical imaging device and the second medical image is an image of the subject taken with a second medical imaging device different than the first medical imaging device.

21. The computer system of claim 19, wherein the first medical image is an image of a subject taken at a first time and the second medical image is an image of the subject taken at a second time later than the first point in time.

22. The computer system of claim 17, further comprising adding a joint intensity distribution to the library of learned joint intensity distributions based on the generated displacement field.

23. The computer system of claim 17, wherein the ability to accurately generating a displacement field increases as the library of learned joint intensity distributions increases.

24. The computer system of claim 17, wherein the automatically selecting a preferred learned joint intensity distribution from among a library of learned joint intensity distributions comprises minimizing the energy E for the displacement field u, according to the formula: E(u)=Eₚᵣᵢₒᵣ(u)+α₁E_{MI}(u)+α₂Eₛₘₒₒₜₕ(u), wherein
$${E}_{prior} ( u ) = - log ( {\sum }_{j = 1}^{m} exp ( - \frac{{I}_{KL} ( {p}_{u} , {p}_{j} )}{σ} ) ) ;$$
$${E}_{MI} ( u ) = - {I}_{MI} ( ( {f}_{1} ( x ) , {f}_{2} ( x + u ) ) ; \\ {E}_{smooth} ( u ) = \int {\vert ∇ u \vert}^{2} d x ;$$
α₁ and α₂ are the respective contributions of the mutual information and smoothness;
$${I}_{KL} ( {p}_{u} , {p}_{j} ) = {\int }_{{ℜ}^{2}} {p}_{u} ( {i}_{1} , {i}_{2} ) log \frac{{p}_{u} ( {i}_{1} , {i}_{2} )}{{p}_{j} ( {i}_{1} , {i}_{2} )} d {i}_{1} d {i}_{2} ; and$$
$$σ = \frac{1}{m} {\sum }_{i = 1}^{m} {min}_{j \neq i} {I}_{KL} ( {p}_{i} , {p}_{j} ) .$$
